(19) United States
(12) Patent Application Publication
(10) Pub. No.: US 2026/0242916 A1
(43) Pub. Date: Aug. 20, 2026

(54) FE-CO BASED ALLOY SUBSTRATE AND MANUFACTURING METHOD THEREOF, FE-CO BASED ALLOY COATED SUBSTRATE AND MANUFACTURING METHOD THEREOF, AND LAMINATED CORE MEMBER

(71) Applicant: Proterial, Ltd., Tokyo (JP)

(72) Inventor: Yoshiyuki Fujihara, Tokyo (JP)

(73) Assignee: Proterial, Ltd., Tokyo (JP)

(21) Appl. No.: 19/160,465

(22) PCT Filed: Feb. 28, 2024
(86) PCT No.: PCT/JP2024/007448

§ 371 Date: Aug. 27, 2025

(30) Foreign Application Priority Data
Mar. 3, 2023 (JP) 2023-033240

(51) Int. Cl. C22F 1/16; C22C 30/00; H01F 1/14

(52) U.S. Cl. CPC C22F 1/16; C22C 30/00; H01F 1/14; C22C 2202/02

(57) ABSTRACT

A method for manufacturing Fe—Co based alloy substrate includes: a cold rolling step of performing cold rolling on a cold rolling material of an Fe—Co based alloy to obtain a cold rolled material having a thickness of 0.5 mm or less, and a step of performing magnetic annealing on the cold rolled material under conditions of a vacuum degree of 0.001 to 0.05 Pa, a heating temperature of 750 to 900° C., and a heating and holding time of 1 to 5 h.

### TECHNICAL FIELD

The present invention relates to an Fe—Co based alloy substrate and a manufacturing method thereof, an Fe—Co based alloy coated substrate and a manufacturing method thereof, and a manufacturing method of a laminated core member.

### RELATED ART

In recent years, electrification in the automotive and aircraft fields has been actively studied from the perspective of global environmental protection, and further higher output, miniaturization, and higher efficiency of rotating machines to be mounted have been required. For such high performance of rotating machines, improvement of saturation magnetic flux density and improvement of iron loss characteristics of magnetic members used as magnetic core materials of rotating machines are required.

As a general magnetic member for rotating machines, an Fe-approximately 3 mass % Si based alloy called non-oriented electrical steel sheet is used, but as a magnetic member that may obtain even higher saturation magnetic flux density, an Fe—Co based alloy called Permendur has been known for a long time.

Here, magnetic members for rotating machines are generally processed into member shapes and laminated and integrated using the above-mentioned non-oriented electrical steel sheets or Permendur substrates, but in order to obtain good magnetic properties, heat treatment called magnetic annealing (or magnetic annealing, finish annealing, final annealing) is necessary. For example, Patent Document 1 discloses magnetic annealing of Fe—Co based alloys in hydrogen, and Patent Document 2 proposes magnetic annealing in an inert gas atmosphere, etc.

### CITATION LIST

### Patent Literature

Patent Document 1: Japanese Patent Application Laid-Open Publication No. 59-162251
Patent Document 2: Japanese Patent Application Laid-Open Publication No. 2012-521649

### SUMMARY OF INVENTION

### Technical Problem

The magnetic annealing disclosed in the above-mentioned Patent Document 1 and Patent Document 2 is essential for obtaining good magnetic properties of magnetic members for rotating machines. On the other hand, in the case of using reducing hydrogen or inert gases such as argon or nitrogen for magnetic annealing, depending on the purity of the gas used, surface oxidation and nitridation may proceed excessively and magnetic properties may be impaired, and there are also concerns about production aspects such as preparing high-purity gases and safety aspects in using gases. Therefore, the object of the present invention is to provide an Fe—Co based alloy substrate and a manufacturing method thereof, an Fe—Co based alloy coated substrate and a manufacturing method thereof, and a laminated core member that can prevent excessive oxidation and nitridation of the substrate surface and obtain good magnetic properties while suppressing the usage amount of reducing or inert gas for magnetic annealing.

### Solution to Problem

The present inventor investigated the relationship between the atmosphere of magnetic annealing using Fe—Co based alloy substrates and magnetic properties, and oxide layers or nitride layers on the substrate surface. As a result, the present inventor found that by performing magnetic annealing in a vacuum atmosphere with controlled vacuum degree, excessive oxidation and nitridation of Fe—Co based alloy substrates can be prevented and good magnetic properties can be obtained, and reached the present invention.

That is, one embodiment of the present invention is a method for manufacturing an Fe—Co based alloy substrate that performs: a cold rolling step of preparing a cold rolling material of an Fe—Co based alloy and performing cold rolling on the cold rolling material to obtain a cold rolled material having a thickness of 0.5 mm or less; and a magnetic annealing on the cold rolled material under conditions of a vacuum degree 0.01 to 0.5 Pa, a heating temperature of 750 to 900° C., and a heating and holding time of 1 to 5 h.

Another embodiment of the present invention is an Fe—Co based alloy substrate including an oxide layer on a surface of an Fe—Co based alloy with a thickness of 0.5 mm or less, in which the oxide layer has a thickness of 10.0 nm or less.

Preferably, the oxide layer is a V-containing oxide layer.

Another embodiment of the present invention is a method for manufacturing an Fe—Co based alloy coated substrate that further includes a coating step of coating the cold rolled material with an insulating film to obtain a coated cold rolled material, and performing the magnetic annealing on the coated cold rolled material.

Another embodiment of the present invention is an Fe—Co based alloy coated substrate that further includes an insulating film of 0.05 to 2.0 μm on a surface of the Fe—Co based alloy substrate.

Another embodiment of the present invention is a laminated core member in which the Fe—Co based alloy coated substrate is laminated.

### Effects of Invention

According to the present invention, it is possible to obtain an Fe—Co based alloy substrate, an Fe—Co based alloy coated substrate, and a laminated core member that can achieve good magnetic properties by suppressing the usage amount of reducing hydrogen or inert gas such as argon or nitrogen used in magnetic annealing, and preventing excessive oxidation and nitridation of the substrate surface.

### BRIEF DESCRIPTION OF DRAWINGS

FIG. 1 is a TEM photograph showing samples of Present Invention Examples and Comparative Examples.

### DESCRIPTION OF THE EMBODIMENTS

First, in the present invention, an Fe—Co based alloy substrate is used for the magnetic member used as a magnetic core material of a rotating machine. The Fe—Co based alloy substrate of the present invention refers to a strip-shaped (coil), rectangular (sheet), or component-shaped thin plate. The plate thickness of the Fe—Co based alloy substrate of the present invention may be, for example, 0.5 mm or less. A preferable plate thickness is 0.25 mm or less. Here, the Fe—Co based alloy in the present invention has Fe+Co of 95% or more in mass %, contains 25 to 60% Co, and the remaining part is unavoidable impurities, or contains one or two or more types of elements of V, Mn, Si, Al, Zr, B, Ni, Ta, Nb, W, Ti, Mo, Cr in a total of up to 5.0% in mass %, with the remaining part being unavoidable impurities. The preferable lower limit of Co amount is 40%. This enables high magnetic flux density to be exhibited.

Next, elements that may be contained in the Fe—Co based alloy of the present invention will be described. The Fe—Co based alloy of the present invention preferably contains V: 1.70 to 2.10%, Mn: 0.01 to 0.40%, Si: 0.01 to 1.0% in mass % in order to improve magnetic properties and cold workability. In addition to containing the above-mentioned elements, one or two or more types of elements of Al, Zr, B, Ni, Ta, Nb, W, Ti, Mo, Cr may be contained up to a total of 2.5% in mass %. Other impurity elements that are unavoidably included include, for example, C, S, P, O, and it is preferable that the upper limit of each of these be 0.1%. A preferable Fe—Co based alloy is C: 0.1% or less, V: 1.70 to 2.10%, Mn: 0.01 to 0.40%, Si: 0.01 to 1.0%, Co: 25 to 60%, with the remaining part being Fe and unavoidable impurities.

In the manufacturing method of the present invention, first, cold rolling is performed on a cold rolling material (hereinafter also referred to as intermediate material) having the above-mentioned Fe—Co based alloy composition and made disordered by rapid cooling treatment from equal to or higher than the ordering temperature of around 730° C. For this intermediate material, hot rolled material or strip-shaped material obtained by applying preliminary cold rolling to hot rolled material may be used. Subsequently, in the manufacturing method according to the present invention, cold rolling is performed on the intermediate material to obtain a desired plate thickness, thereby obtaining cold rolled material with a plate thickness of 0.5 mm or less. By performing magnetic annealing on the cold rolled material, an Fe—Co based alloy substrate having good magnetic properties can be obtained. Before magnetic annealing, processing into component shape may be performed using press punching, wire cutting, laser processing, etc. Magnetic annealing may also be performed after forming a laminated and integrated core state for use as magnetic core material of rotating machines.

In the present invention, the above-mentioned magnetic annealing is performed using a vacuum heating furnace under conditions of vacuum degree 0.001 to 0.05 Pa, heating temperature 750 to 900° C., and heating and holding time 1 to 5 h. This vacuum magnetic annealing is one of the features of the present invention. This enables a manufacturing method for Fe—Co based alloy substrate that is capable of obtaining good magnetic properties by preventing excessive oxidation and nitridation of the substrate surface while suppressing the usage amount of reducing or inert gas for magnetic annealing. In the case of achieving higher vacuum degree, time is required for evacuating the furnace, and in the case of lower vacuum degree, deterioration of magnetic properties due to excessive oxidation of the substrate surface is a concern, so the vacuum degree is controlled to 0.001 to 0.05 Pa. The preferable lower limit of vacuum degree is 0.002 Pa. The preferable upper limit of vacuum degree is 0.01 Pa, and the more preferable upper limit of vacuum degree is 0.005 Pa. The vacuum degree of the present invention refers to the achieved vacuum degree during heating and holding. The heating temperature may be any temperature that is equal to or higher than the temperature at which the cold rolled structure of the Fe—Co based alloy substrate recrystallizes and does not exceed the a (BCC crystal structure)-γ (FCC crystal structure) transformation temperature, and the heating temperature is in the range of 750 to 900° C. The preferable lower limit of heating temperature is 800° C., and the preferable upper limit of heating temperature is 890° C. For the heating and holding time of the present invention, if less than 1 h, recrystallization of the cold rolled structure does not proceed sufficiently, and if exceeding 5 h, the crystal grain growth rate becomes slow and significant improvement in magnetic properties cannot be expected, so it is set to 1 to 5 h. After completion of heating and holding in magnetic annealing, since the cooling process under vacuum requires time for cooling the substrate, the cooling process may control the cooling rate using atmosphere gas such as hydrogen, argon, nitrogen, etc.

The Fe—Co based alloy substrate of the present invention obtained by the above-mentioned manufacturing method of the present invention has an oxide layer with a thickness of 10.0 nm or less on the substrate surface. The above oxide layer does not damage the magnetic properties of the Fe—Co based alloy substrate, and is also expected to have effects such as slightly enhancing the corrosion resistance of the substrate surface and the wettability and affinity with adhesives that may be used in response to laminating the substrate as a magnetic core material for rotating machines. Preferably, the oxide layer formed by the vacuum magnetic annealing of the present invention has a V-containing oxide layer containing V. By having a relatively stable and continuous layered V-containing oxide layer, it can be expected to stably exhibit the advantageous effects of the above-mentioned oxide layer of the present invention. To confirm whether the V-containing oxide layer is “continuous layered”, for example, the V-containing oxide layer is confirmed by element mapping at a magnification of 5 million times using FE-TEM (confirming element maps of V and O), and if the V-containing oxide layer is continuously formed within the field of view, it may be said that the target alloy substrate has a continuous layered V oxide layer. The preferable thickness of the V-containing oxide layer is 7 nm or less. The V-containing oxide layer in the present invention may be measured, for example, by using element mapping based on FE-TEM and the length measurement function of the FE-TEM analysis tool.

Next, the Fe—Co based alloy coated substrate of the present invention will be described. The Fe—Co based alloy coated substrate of the present invention can be obtained by coating an insulating film on the above-mentioned Fe—Co based alloy substrate before magnetic annealing (after cold rolling). For example, laminated core members used in rotating machines and the like can improve electrical insulation during lamination by having an insulating film on the Fe—Co based alloy substrate surface, thereby contributing to enhanced performance of the laminated core members. The Fe—Co based alloy coated substrate of the present invention has excellent magnetic properties even after insulating film formation. The insulating film in the present invention may be coated on only one side of the substrate or on both sides of the substrate. The thickness of the insulating film (total value of insulating films formed on both sides of the substrate) is not particularly limited, but may be, for example, 0.05 to 2.0 μm. Here, the film type of the insulating film may be selected from known insulating films such as magnesium oxide (MgO), zirconium oxide (ZrO₂), aluminum oxide (Al₂O₃), and the like. The method for coating the insulating film onto the substrate in the present invention is not particularly limited, and known techniques such as dip coating and roll coating may be implemented.

The laminated core member formed by laminating multiple sheets of the above-mentioned Fe—Co based alloy coated substrate has the characteristics of high magnetic flux density of the substrate and high electrical insulation between laminations, contributing to enhanced performance of rotating machines and the like.

### EXAMPLES

### Example 1

Cold rolling was performed on cold rolling material of Fe—Co based alloy having the composition shown in Table 1 to prepare cold rolled material. Subsequently, ring test specimens with an outer diameter of 45 mm and inner diameter of 33 mm for magnetic property measurement were collected by press working, and test specimens with a width of 25 mm and length of 110 mm for surface analysis were collected by shear cutting. Then, each test specimen was subjected to magnetic annealing at a heating temperature of 850° C. and holding time of 3 h under each atmosphere of hydrogen, argon, nitrogen, and vacuum (two conditions: high vacuum degree: approximately 0.004 Pa, low vacuum degree: approximately 0.04 Pa). The cooling process after the end of heating and holding in magnetic annealing under hydrogen, argon, and nitrogen atmospheres was natural cooling in the furnace. The cooling process in magnetic annealing under vacuum atmosphere was adjusted by flowing a small amount of nitrogen gas into the vacuum furnace and controlling the cooling time to reach 100° C. or below over approximately 3 hours.

Subsequently, four ring test specimens each for every magnetic annealing atmosphere were stored in plastic ring cases (with interlayer paper inserted between rings), and 100 primary and 50 secondary windings were applied to measure DC magnetic properties and AC magnetic properties. For DC magnetic properties, maximum relative permeability (μm), coercive force (Hc), and magnetic flux density (B800) were measured from hysteresis curves including initial magnetization curves at an applied magnetic field of 800 A/m. For AC magnetic properties, iron loss (W10/400) at operating magnetic flux density of 1T and operating frequency of 400 Hz was measured. The results are shown in Table 2.

TABLE 1

| Plate | | | | | | |
|---|---|---|---|---|---|---|
| thickness | Component (mass %) | | | | | |
| (mm) | C | Si | Mn | Co | V | Remaining part |
| 0.2 | 0.003 | 0.05 | 0.04 | 49.0 | 1.91 | Fe and unavoidable |
| | | | | | | impurities |

TABLE 2

| | | DC magnetic properties | | | | |
|---|---|---|---|---|---|---|
| | | Maximum | | | AC magnetic | |
| | | relative | Coercive | Magnetic | properties | |
| | Magnetic | permeability | force | flux density | Iron loss | |
| | annealing | μm | Hc | B800 | W10/400 | |
| No | atmosphere | — | (A/m) | (T) | (W/kg) | Remarks |
| 1 | Hydrogen | 22,428 | 34.4 | 2.20 | 9.2 | Comparative |
| | | | | | | Example |
| 2 | Argon | 21,856 | 32.6 | 2.20 | 9.3 | Comparative |
| | | | | | | Example |
| 3 | Nitrogen | 8,926 | 46.3 | 2.07 | 11.7 | Comparative |
| | | | | | | Example |
| 4 | High vacuum | 23,077 | 31.7 | 2.19 | 9.6 | Present |
| | | | | | | Invention |
| | | | | | | Example |
| 5 | Low vacuum | 17,436 | 28.6 | 2.18 | 10.9 | Present |
| | | | | | | Invention |
| | | | | | | Example |

From the results in Table 2, the DC magnetic properties and AC magnetic properties of Present Invention Examples No. 4 (vacuum: approximately 0.004 Pa) and No. 5 (vacuum: approximately 0.04 Pa), which do not use atmosphere gas until the end of heating and holding in magnetic annealing, are equivalent magnetic properties to Comparative Examples No. 1 (hydrogen) and No. 2 (argon) that used atmosphere gas from the heating process of magnetic annealing, and it was confirmed that better magnetic properties than Comparative Example No. 3 (nitrogen) may be obtained.

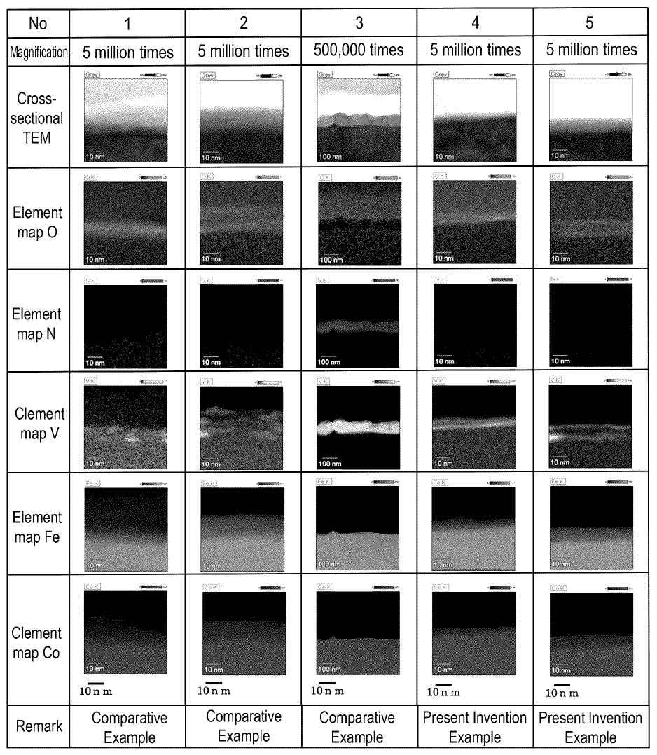

The surface analysis test specimens with a width of 25 mm and length of 110 mm that were subjected to magnetic annealing in each atmosphere were further cut into test specimens with a width of 10 mm and length of 15 mm by shear cutting. After protecting the test specimen surface with a C film, the specimens were processed into film-like cross-sectional test specimens parallel to the width direction from the outermost surface of the test specimens using FIB-SEM. Then, cross-sectional TEM and element map analysis of O, N, V, Fe, and Co based on FE-TEM were performed, and the film thickness of the oxide layer or nitride layer formed on the outermost surface of the Fe—Co based alloy substrate was measured using the length measurement function of the FE-TEM analysis tool. The results are shown in Table 3 and FIG. 1. In FIG. 1, the lower side of the image is the Fe—Co based alloy substrate side.

TABLE 3

| | Magnetic | Film thickness | |
|---|---|---|---|
| | annealing | of oxide layer | |
| No | atmosphere | or nitride layer | Remarks |
| 1 | Hydrogen | 11.4 nm (oxide layer) | Comparative Example |
| 2 | Argon | 15.3 nm (oxide layer) | Comparative Example |
| 3 | Nitrogen | 81.5 nm (nitride layer) | Comparative Example |
| 4 | High vacuum | 5.5 nm (oxide layer) | Present Invention Example |
| 5 | Low vacuum | 9.6 nm (oxide layer) | Present Invention Example |

From the results in Table 3, the oxide layers formed on the substrate surfaces of Present Invention Examples No. 4 (vacuum: approximately 0.004 Pa) and No. 5 (vacuum: approximately 0.04 Pa), which do not use atmosphere gas until the end of heating and holding in magnetic annealing, are 5.5 nm and 9.6 nm respectively, which are thinner than the film thicknesses of the oxide layers or nitride layers of Comparative Examples No. 1 (hydrogen): 11.4 nm, No. 2 (argon): 15.3 nm, and No. 3 (nitrogen): 81.5 nm that used atmosphere gas from the heating process of magnetic annealing. It was confirmed that the progress of surface oxidation and nitridation was suppressed, resulting in clean surfaces.

Also, the oxide layers formed on the substrate surfaces of Present Invention Examples No. 4 (vacuum: approximately 0.004 Pa) and No. 5 (vacuum: approximately 0.04 Pa) contain V, and compared to the discontinuous V-containing oxide layers of Comparative Examples No. 1 (hydrogen) and No. 2 (argon) which have good magnetic properties, it was confirmed from the element maps of V and O in FIG. 1 that they are relatively stable and continuous layered structures. This is expected to provide effects such as slightly enhancing the corrosion resistance of the substrate surface and the wettability and affinity with adhesives that may be used in the case of laminating substrates as magnetic core materials for rotating machines, without damaging the magnetic properties of the Fe—Co based alloy substrate.

### Example 2

The characteristics of the Fe—Co based alloy coated substrate of the present invention were confirmed. Cold rolled materials of Fe—Co based alloys shown in Table 4 were prepared, and coated with a solution of Mg(OH)₂ solution, which was obtained by dispersing Mg(OH)₂ powder serving as a precursor of MgO as a solute in an aqueous solvent, by general roll coating. After that, drying treatment at a temperature of 140° C. for 5 min in air and baking treatment at a temperature of 450° C. for 10 min in nitrogen were performed to obtain Fe—Co based alloy coated substrates having magnesium oxide (MgO) films (film thickness of approximately 0.7 mm on one side) on both surfaces.

Subsequently, after collecting ring test specimens with an outer diameter of 45 mm and an inner diameter of 33 mm for magnetic property measurement by press working, magnetic annealing was performed on each test specimen at a heating temperature of 850° C. with a holding time of 3 h under each atmosphere of hydrogen, argon, nitrogen, and vacuum (high vacuum degree: approximately 0.004 Pa). The cooling process after the end of heating and holding in magnetic annealing under hydrogen, argon, and nitrogen atmospheres was natural cooling in the furnace. Also, the cooling process in magnetic annealing under vacuum atmosphere was adjusted such that a small amount of nitrogen gas was flowed into the vacuum furnace and the cooling time was controlled to reach 100° C. or below over approximately 3 h.

Subsequently, 8 ring test specimens each for each magnetic annealing atmosphere were stored in plastic ring cases (with interlayer paper inserted between rings), and 100 primary and 50 secondary windings were applied to measure DC magnetic properties and AC magnetic properties. For DC magnetic properties, maximum relative permeability (μm), coercive force (Hc), and magnetic flux density (B800) were measured from hysteresis curves including initial magnetization curves at an applied magnetic field of 800 A/m. For AC magnetic properties, iron loss (W10/400) at an operating magnetic flux density of 1T and operating frequency of 400 Hz was measured. The results are shown in Table 5.

TABLE 4

| Plate | | | | | | |
|---|---|---|---|---|---|---|
| thickness | Component (mass %) | | | | | |
| (mm) | C | Si | Mn | Co | V | Remaining part |
| 0.1 | 0.001 | 0.04 | 0.05 | 48.9 | 1.89 | Fe and unavoidable |
| | | | | | | impurities |

TABLE 5

| | | DC magnetic properties | | | | |
|---|---|---|---|---|---|---|
| | | Maximum | | | AC magnetic | |
| | | relative | Coercive | Magnetic | properties | |
| | Magnetic | permeability | force | flux density | Iron loss | |
| | annealing | μm | Hc | B800 | W10/400 | |
| No | atmosphere | — | (A/m) | (T) | (W/kg) | Remarks |
| 6 | Hydrogen | 19,100 | 40.2 | 2.19 | 7.8 | Comparative |
| | | | | | | Example |
| 7 | Argon | 17,363 | 43.8 | 2.19 | 8.0 | Comparative |
| | | | | | | Example |
| 8 | Nitrogen | 5,496 | 71.6 | 2.00 | 8.5 | Comparative |
| | | | | | | Example |
| 9 | High vacuum | 18,354 | 41.8 | 2.18 | 8.0 | Present |
| | | | | | | Invention |
| | | | | | | Example |

From the results in Table 5, it was confirmed that even in alloy coated substrates coated with insulating films, the DC magnetic properties and AC magnetic properties of No. 9 of the Present Invention Example, which does not use atmosphere gas until the end of heating and holding in magnetic annealing, are equivalent magnetic properties to No. 6 (hydrogen) and 7 (argon) of the Comparative Examples that used atmosphere gas from the heating process of magnetic annealing, and better magnetic properties than No. 8 (nitrogen) of the Comparative Example may be obtained.

To the claims:

1. A method for manufacturing Fe—Co based alloy substrate, the method comprising:
a cold rolling step of performing cold rolling on a cold rolling material of an Fe—Co based alloy to obtain a cold rolled material having a thickness of 0.5 mm or less, and
a step of performing magnetic annealing on the cold rolled material under conditions of a vacuum degree of 0.001 to 0.05 Pa, a heating temperature of 750 to 900° C., and a heating and holding time of 1 to 5 h.

2. An Fe—Co based alloy substrate, comprising an oxide layer on a surface of an Fe—Co based alloy having a thickness of 0.5 mm or less, wherein the oxide layer has a thickness of 10.0 nm or less.

3. The Fe—Co based alloy substrate according to claim 2, wherein the oxide layer is a V-containing oxide layer.

4. A method for manufacturing Fe—Co based alloy coated substrate, further comprising: a coating step of coating the cold rolled material according to claim 1 with an insulating film to obtain a coated cold rolled material, and
performing the magnetic annealing according to claim 1 on the coated cold rolled material.

5. An Fe—Co based alloy coated substrate, further comprising an insulating film of 0.05 to 2.0 μm on a surface of the Fe—Co based alloy substrate according to claim 2.

6. A laminated core member, laminated with the Fe—Co based alloy coated substrate according to claim 5.

7. An Fe—Co based alloy coated substrate, further comprising an insulating film of 0.05 to 2.0 μm on a surface of the Fe—Co based alloy substrate according to claim 3.
